(19) United States
(12) Patent Application Publication
(10) Pub. No.: US 2022/0386662 A1
(43) Pub. Date: Dec. 8, 2022

(54) INSTANT FOOD PRODUCTS

(71) Applicant: MR LEE'S PURE FOODS CO. LTD, Bournemouth (GB)

(72) Inventor: Christopher Fung, Bournemouth (GB)

(73) Assignee: MR LEE'S PURE FOODS CO. LTD, Bournemouth (GB)

(21) Appl. No.: 17/642,124

(22) PCT Filed: Sep. 10, 2020
(86) PCT No.: PCT/GB2020/052174

§ 371 Date: Mar. 10, 2022

(30) Foreign Application Priority Data
Sep. 10, 2019 (GB) 1913028.5

(51) Int. Cl. A23L 7/143; A23L 7/135; A23L 7/161

(52) U.S. Cl. CPC A23L 7/143; A23L 7/135; A23L 7/161

(57) ABSTRACT

The present invention relates to a dry composition for preparing a food product, the composition comprising: a. at least one instant grain; and b. at least one texturizing agent; wherein a concentration ratio of the at least one texturizing agent to the at least one instant grain is at least 1.00:49.00. The invention also relates to a ready-to-eat food product, the food product comprising: a. at least one instant grain; and b. at least one texturizing agent; wherein a concentration ratio of the at least one texturizing agent to the at least one instant grain is at least 1.00:49.00. The invention further relates to methods of manufacturing a dry composition and methods of preparing a ready-to-eat food product.

The present invention relates to food products, such as grain-based food products, as well as methods for manufacturing the same.

Grains, such as oats and rice, have been a staple of the human diet for many years. Grain-based food products contain a number of constituents associated with health benefits, including: beta-glucan, antioxidants, and micronutrients. Indeed, numerous studies have shown that regular consumption of grain-based food products can help lower blood cholesterol, reduce the risk of heart disease, promote healthy blood flow, and maintain healthy blood pressure levels. Additionally, complex carbohydrates and/or fibre comprised in such products have been implicated in slowing digestion and stabilising blood glucose levels.

Traditional oat porridge is made by combining oats (typically rolled or steel-cut oats) with milk and/or water and cooking in a pan. Another grain-based food product is congee, which is a rice porridge popular in Asia. It is traditionally made by combining at least rice and water and cooking in a pan. Additional ingredients such as spices, sugar, honey, chicken, vegetables and seafood can be added. Typically, congee is cooked for over 1 hour.

Although providing products with a number of advantageous organoleptic properties, the traditional methods for making grain-based food products (e.g. oat porridge and congee) are time-consuming, require a pan and a means of cooking, and/or require the use of multiple ingredients. Hence, such methods are not aligned with consumer demands for convenience, portability, and ease of preparation.

Instant and quick cook grain-based products (such as oat porridge and congee) have been developed to reduce cooking times. Some of these products require only the addition of hot water while others require rehydration and heating (e.g. using a microwave). The shorter cooking time achieved by these products is a result of using instant grains such as instant oats (e.g. which have been rolled such that they are much thinner than traditional rolled or steel-cut oats) or instant rice (e.g. which has been pre-cooked). Although such products have shorter cooking and preparation times, they also have inferior organoleptic properties when compared to grain-based food products made using traditional methods. For example, the instant products suffer from textural defects.

The present invention overcomes one or more of the above-mentioned problems.

The present inventor has found that a combination of an instant grain with at least one texturizing agent (e.g. an instant grain and/or a puffed grain) at a claimed concentration ratio yields a product with improved organoleptic properties. Advantageously, the invention provides a ready-to-eat food product (and compositions suitable for preparing the same) that can be prepared rapidly requiring minimal additional ingredients and/or equipment.

Thus, in one aspect the invention provides a dry composition for preparing a food product, the composition comprising:
a. at least one instant grain; and
b. at least one texturizing agent;
   wherein a concentration ratio of the at least one texturizing agent to the at least one instant grain is at least 1.00:49.00.

In other words, in one aspect the invention provides a dry composition for preparing a food product, the composition comprising:
a. an instant grain; and
b. a texturizing agent (preferably a puffed [e.g. popped] grain);
   wherein a concentration ratio of the texturizing agent (preferably the puffed [e.g. popped] grain) to the instant grain is at least 1.00:49.00.

The term “dry composition” as used herein refers to a composition in which no, or substantially no, water is present. In some embodiments the term “dry composition” refers to a composition in which the only water present is that associated with, or absorbed by, an ingredient of the composition. In one embodiment the term “dry composition” refers to a composition having a water content of less than 5 wt. %, such as less than 1 or 0.1 wt. %. Preferably the term “dry” refers to a composition having a water content of less than 0.01 wt. %.

In one aspect the invention provides a ready-to-eat food product, the food product comprising:
a. at least one instant grain; and
b. at least one texturizing agent;
   wherein a concentration ratio of the at least one texturizing agent to the at least one instant grain is at least 1.00:49.00.

In other words, in one aspect the invention provides a ready-to-eat food product, the food product comprising:
a. an instant grain; and
b. a texturizing agent (preferably a puffed [e.g. popped] grain);
   wherein a concentration ratio of the texturizing agent (preferably the puffed [e.g. popped] grain) to the instant grain is at least 1.00:49.00.

In one aspect the invention provides a ready-to-eat food product prepared from a dry composition, the dry composition comprising:
a. at least one instant grain; and
b. at least one texturizing agent;
   wherein a concentration ratio of the at least one texturizing agent to the at least one instant grain is at least 1.00:49.00.

In other words, in one aspect the invention provides a ready-to-eat food product prepared from a dry composition, the dry composition comprising:
a. an instant grain; and
b. a texturizing agent (preferably a puffed [e.g. popped] grain);
   wherein a concentration ratio of the texturizing agent (preferably the puffed [e.g. popped] grain) to the instant grain is at least 1.00:49.00.

A composition and ready-to-eat food product of the invention may be referred to herein as a grain-based composition and a grain-based ready-to-eat food product, respectively.

The ready-to-eat food product is suitably a rehydrated and heated version of a dry composition of the present invention. The composition may be rehydrated by any means known to the person skilled in the art, for example by addition of water or an alternative formulation comprising water, such as milk. A ready-to-eat food product may have a water content of at least 5 wt. %. In one embodiment a ready-to-eat food product may have a water content of at least 10, 15, 20, 25, 30, 35, 40, 50, 60 or 70 wt. %. Preferably, a ready-to-eat food product may have a water content of at least 80 wt. %.

Preferably, the composition is rehydrated using water. In such embodiments the composition may comprise a dehydrated milk, such as a milk powder.

The term “milk” is used herein to refer to either non-animal or animal milk. The term “milk” may refer to coconut milk, cow's milk, goat's milk, sheep's milk, almond milk, oat milk, or almond milk. Preferably the milk is cow's milk. Most preferably, the milk is coconut milk. Advantageously, coconut milk is suitable for consumers adopting a dairy-free or vegan diet.

The composition or food product of the invention may comprise at least one instant grain selected from the group consisting of: rice, oat, wheat, quinoa, millet, barley, corn, triticale, sorghum, rye, spelt, wild rice, chia, amaranth, and buckwheat.

The term “at least one instant grain” may mean at least 1, 2, 3 or 4 different instant grains. Preferably, the term at least one instant grain may mean 1 instant grain.

In one embodiment, the term “at least one instant grain” as used herein means a plurality of instant grains, preferably two instant grains (e.g. rice and corn semolina, preferably wherein the rice is present at a higher concentration than corn semolina). For example, the composition or food product may comprise at least two instant grains.

Where a plurality of instant grains is used, the concentration ratio of texturizing agent to instant grain may be a concentration ratio of at least one texturizing agent to the plurality of instant grains. For example, the concentration ratio may be a concentration ratio of the at least one texturizing agent to the at least two instant grains.

Thus, in one aspect the invention provides a dry composition for preparing a food product, the composition comprising:
a. a plurality of instant grains (e.g. two instant grains); and
b. at least one texturizing agent;
   wherein a concentration ratio of the at least one texturizing agent to the plurality of instant grains is at least 1.00:49.00.

In another aspect the invention provides a dry composition for preparing a food product, the composition comprising:
a. a plurality of instant grains (e.g. two instant grains); and
b. at least one texturizing agent;
   wherein a concentration ratio of the at least one texturizing agent to the plurality of instant grains is at least 1.00:49.00.

Embodiments herein describing a concentration ratio of a texturizing agent to at least one instant grain may also be applied to a plurality of instant grains.

In a preferred embodiment an instant grain is an instant oat grain. An instant oat grain may be present in an oat porridge or a rice porridge (e.g. congee) of the invention. In the latter, the instant oat grain may be used as a texturizing agent. Instant oat grains are commercially available and are typically obtainable by steaming oat groats and rolling to a desired average thickness.

The term “instant oat” or “instant oat grain” as used herein also encompasses “quick cook oat grains”. The “quick cook oat grains” have slightly different properties to other forms of “instant oat grains” as described below. In one embodiment the term “instant oat grain” excludes a “quick cook oat grain” as described herein. Thus, in one embodiment an instant oat grain is not a quick cook oat grain.

A “quick cook oat grain” typically has a mean average thickness of less than 0.6 mm, e.g. 0.45-0.54 mm. A “quick cook oat grain” may be larger than an instant oat grain. A “quick cook oat grain” may be defined functionally as one that can only yield porridge having substantially no uncooked/undercooked oat grains when water/milk is added, heated until boiling (or close to boiling) in a microwave and/or simmered for example on a hob for up to 5 minutes or for up to 3 minutes, such as 3-5 minutes. Alternatively, a “quick cook oat grain” may be defined functionally as one that can only yield porridge having substantially no uncooked/undercooked oat grains when boiling water/milk is added and the oat grains heated in a microwave and/or simmered for example on a hob for up to 5 minutes or for up to 3 minutes, such as 3-5 minutes. Thus, in one embodiment, a “quick cook oat grain” may be one that when boiling water is added to the oat grain and left to heat for up to 5 minutes (e.g. up to 3 minutes) without the addition of further external heat (e.g. by simmering for example on a hob or heating in a microwave) said porridge contains at least some uncooked/undercooked oat grains. In one embodiment, at least 50%, 60% or 70% (preferably at least 80%) of the oat grains present in a “quick cook oat grain” component of a composition or food product described herein have a thickness as indicated herein.

In embodiments where a texturizing agent of the invention is an instant oat grain, said oat grain may be a quick cook oat grain.

In another embodiment an “instant oat grain” is one having a mean average thickness of less than 0.508 mm. An “instant oat grain” may therefore be smaller than a non-instant oat grain and may also be smaller than a quick cook oat grain. In embodiments where the instant oat grain is a base grain of the composition or food product (e.g. oats in oat porridge) and not a texturizing agent it is preferred that the term “instant oat grain” excludes quick cook oat grains. In one embodiment, when a “quick cook oat grain” is to be excluded, an “instant oat grain” may be defined functionally as one that can be cooked to yield porridge having substantially no uncooked/undercooked oat grains when boiling water is added to the oat grain and left to heat for up to 5 minutes (preferably for up to 3 minutes) without the addition of further external heat (e.g. by simmering for example on a hob or heating in a microwave).

The term “substantially no uncooked/undercooked oat grains” may mean that less than 5%, 3% or 1% of the oat grains are uncooked/undercooked. The term “contains at least some uncooked/undercooked oat grains” may mean 5% or more, 10% or more or 20% or more of the oat grains are uncooked/undercooked.

The term “instant oat grain” as used herein may refer to an oat grain having a mean average thickness of 0.483 mm or less. In one embodiment an “instant oat grain” refers to an oat grain having a mean average thickness of less than 0.330 mm, 0.300 mm or 0.200 mm. In one embodiment an instant oat grain has a mean average thickness of 0.330 mm to 0.483 mm. Preferably, an instant oat has a mean average thickness of 0.36 mm to 0.46 mm. The term “instant oat grain” may encompass either whole or parts of oat flakes. The “instant oat grain” may be flaked from a groat cut ⅓ to 1/36 of its size, such as ⅓ to ⅙ or preferably 1/9 to 1/36 of its original size.

In one embodiment, at least 50%, 60% or 70% (preferably at least 80%) of the oat grains present in an “instant oat grain” component of a composition or food product described herein have a thickness and/or size as indicated herein.

In one embodiment a food product of the invention comprises an instant oat grain and is an oat porridge.

In another preferred embodiment an instant grain is an instant rice grain. An instant rice grain is particularly suitable for use in a rice porridge (e.g. congee) of the invention. Instant rice grains (e.g. for preparing conventional instant congee) are commercially available, and typically prepared by pre-cooking the rice, optionally followed by freeze-drying and/or dehydration. A suitable instant rice may be “Rice Porridges”, which can be obtained commercially from Colusa Miliket Foodstuff J.S. Company, 1230 Kha Van Can St., Linh Trung Ward, Thu Duc Dist., HoChiMinh City, Vietnam.

In a preferred embodiment an instant grain (more preferably an instant rice grain) is prepared by extrusion. Extrusion may be achieved by subjecting said instant grain to mechanical stress, such that said instant grain is subjected to a temperature of 100-120° C. for a few seconds (e.g. 1-10 seconds, such as 1-5 seconds).

In one embodiment, an instant rice grain may be defined functionally as one that can be cooked to yield a rice porridge (e.g. congee) having substantially no uncooked/undercooked rice grains when boiling water is added to the rice grain and left to heat for up to 5 minutes (preferably for up to 3 minutes) without the addition of further external heat (e.g. by simmering for example on a hob or heating in a microwave).

The term “substantially no uncooked/undercooked rice grains” may mean that less than 5%, 3% or 1% of the rice grains are uncooked/undercooked.

In one embodiment a food product of the invention comprises an instant rice grain and is a rice porridge (preferably congee).

The instant grains impart a soft, creamy and/or cooked texture to the products of the invention. Therefore, the instant grain may be present at a concentration that imparts a soft, creamy and/or cooked texture to the product of the invention. In other words, the instant grains may be non-granular. A dry composition may comprise an instant grain (i.e. not including any instant grain used as a texturizing agent) at a concentration of at least 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. % or 85 wt. %. A dry composition may comprise an instant grain (i.e. not including any instant grain used as a texturizing agent) at a concentration of ≤35 wt. %, ≤30 wt. %, ≤75 wt. %, ≤70 wt. %, ≤65 wt. %, ≤60 wt. %, ≤55 wt. %, ≤50 wt. %, ≤45 wt. %, ≤40 wt. %, ≤35 wt. %, ≤30 wt. %, ≤25 wt. %, ≤20 wt. %, ≤15 wt. %, ≤10 wt. % or ≤5 wt. %.

A dry composition may comprise an instant grain (i.e. not including any instant grain used as a texturizing agent) at a concentration of 25-90 wt. %, preferably 55-85 wt. %.

The wt. % expressed herein is suitably wt. % of the total dry composition or food product, as will be readily appreciated based on the context.

Preferably the concentration referred to is the total concentration of instant grain present in the dry composition, with the proviso that this excludes any instant grain used as a texturizing agent (e.g. where a plurality of instant grains is used, the concentration recited is preferably the total concentration of said plurality of instant grains).

A composition or food product of the invention comprises at least one texturizing agent. The term “texturizing agent” as used herein encompasses any ingredient that when added to an instant grain of the invention is capable of improving a textural property of the resultant food product, such that the texture of the food product more closely resembles a slow-cooked (non-instant) version of the product. In other words, where a food product is a congee food product, the texturizing agent improves the textural properties of the food product such that it more closely resembles slow-cooked congee. Textural properties as referred to herein can be accurately assessed using expert tasters. The texturizing agent may be present at any concentration that improves the textural properties of the food product.

In one embodiment a texturizing agent is a grain-based texturizing agent. In the context of texturizing agents of the invention no distinction has been made between seeds and grains, as there is some debate as to whether an ingredient is classified as a seed or grain. Thus, the term “grain-based texturizing agent” as used herein encompasses both grain-based and seed-based texturizing agents.

A grain-based texturizing agent may be one or more selected from: oat, rice, wheat, quinoa, millet, barley, corn, triticale, sorghum, rye, spelt, wild rice, chia, amaranth, and buckwheat.

A grain-based texturizing agent may comprise a baked grain product, such as a biscuit, preferably a wafer.

The texturizing agent may be a puffed grain-based texturizing agent (e.g. a puffed grain). The term “puffed” also encompasses “popped”. Puffed grains are commercially available and are typically made by heating grains (e.g. rice kernels) under elevated pressures in the presence of steam.

In one embodiment a puffed grain-based texturizing agent is one or more selected from: a puffed rice, a puffed (e.g. popped) corn, a puffed (e.g. popped) quinoa, a puffed wheat, and a puffed amaranth. In one embodiment, the at least one texturizing agent is one or more selected from: a puffed rice, a puffed (e.g. popped) corn, a puffed wheat, and a puffed amaranth.

In one embodiment the texturizing agent is not a puffed (e.g. popped) quinoa. In one embodiment the texturizing agent is not quinoa.

Preferably, the composition and food product of the invention do not comprise a puffed (e.g. popped) quinoa. Preferably, the composition and food product of the invention do not comprise quinoa.

Preferably the puffed grain is a puffed rice grain. The rice grain may be a brown rice grain.

Advantageously, the present inventors have found that puffed grains (such as puffed rice) mimic the textural properties of a fully-cooked/large grain, as would be found in a slow-cooked version of the food product. Thus, for example, where the food product is an oat porridge, the puffed grains may mimic a fully-cooked jumbo oat and where the food product is a congee, the puffed grains may mimic a large rice grain.

A texturizing agent may be an instant grain, such as an instant grain selected from: oat, rice, wheat, quinoa, millet, barley, corn, triticale, sorghum, rye, spelt, wild rice, chia, amaranth, and buckwheat. Preferably, an instant grain is an instant oat.

Where a texturizing agent is an instant grain, it is preferred that the (second) instant grain selected for use as a texturizing agent is different to the (first) instant grain comprised in the composition or food product.

The compositions and food products of the invention may comprise at least 2, 3, 4, 5, 6, 7 or 8 texturizing agents. Preferably, the compositions and food products comprise (or consist of) 2 texturizing agents.

In a particularly preferred embodiment the compositions and food products of the invention comprise two texturizing agents, wherein the first texturizing agent is a puffed grain and the second texturizing agent in as an instant grain. More preferably, wherein the puffed grain is a puffed rice and the instant grain is an instant oat.

In one embodiment at least one texturizing agent of the invention may be one or more of oat flakes and rice flakes. Preferably the oat flakes or rice flakes are uncooked. The rice flakes may be brown rice flakes.

Thus, in a particularly preferred embodiment, a composition or food product of the invention comprises oat flakes. Said oat flakes may have a mean average thickness of at least 0.508 mm. Said oat flakes may be larger than an instant oat grain (including a quick cook oat grain). The use of oat flakes is particularly advantageous in the preparation of an oat porridge of the invention and is associated with improved organoleptic properties, such as improved texture. Oat flakes having a mean average thickness of at least 0.508 mm are also referred to as “jumbo oats” and are commercially available. The oat flakes are typically obtainable by steaming oat groats and rolling the steamed oats to a desired (mean) average thickness. In one embodiment the oat flakes have a mean average thickness of greater than 0.508 mm, such as a mean average thickness of at least 0.6 mm, 0.7 mm, 0.8 mm or 0.9 mm. In one embodiment an oat flake has a mean average thickness of 0.508-1.016 mm, preferably 0.600 to 1.016 mm. In one embodiment, at least 50%, 60% or 70% (preferably at least 80%) of the oat flakes present in an oak flake component of a composition or food product described herein have a thickness and/or size as indicated herein.

The oat flakes impart a firm texture (e.g. a “bite”) to the products of the invention that is similar to that of traditional oat porridge prepared using traditional methods.

The at least one texturizing agent may be present in a dry composition at a concentration of at least 2 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. % or 85 wt. %. The at least one texturizing agent may be present in a dry composition at a concentration of ≤35 wt. %, ≤30 wt. %, ≤75 wt. %, ≤70 wt. %, ≤65 wt. %, ≤60 wt. %, ≤55 wt. %, ≤50 wt. %, ≤45 wt. %, ≤40 wt. %, ≤35 wt. %, ≤30 wt. %, ≤25 wt. %, ≤20 wt. %, ≤15 wt. %, ≤0 wt. % or ≤5 wt. %.

In one embodiment the at least one texturizing agent may be present in a dry composition at a concentration of 10-75 wt. %, preferably 15-45 wt. %.

Preferably a concentration of a texturizing agent referred to herein is the total concentration (whether presented as wt. % or as a concentration ratio) of texturizing agent present in the dry composition (e.g. where a plurality of texturizing agents is used, the concentration recited is preferably the total concentration of said plurality of texturizing agents). In one embodiment, where only one texturizing agent is indicated, the total concentration (whether presented as wt. % or as a concentration ratio) is the concentration of the indicated texturizing agent present. For example, wherein the composition or food product comprises at least one texturizing agent, wherein the at least one texturizing agent is a puffed grain, said concentration of the puffed grain to the at least one instant grain may be at least 1.00:49.00 (or another concentration ratio described herein).

In one embodiment a concentration ratio of the at least one texturizing agent to the at least one instant grain is at least 1:25, 1:20, 1:15, 1:10, 1:9, 1:8.5, 1:8.0, 1:7.5, 1:7.0, 1:6.5, 1:6.0, 1:5.5, 1:5.0, 1:4.5 or 1:4.25. Preferably, a concentration of the at least one texturizing agent to the at least one instant grain is at least 1:5.5, more preferably at least 1:4.5.

In one embodiment a concentration ratio of the at least one texturizing agent to the at least one instant grain is ≤1:0.11, ≤1:0.20, ≤1:0.25, ≤1:0.30, ≤1:0.35, ≤1:0.40, ≤1:0.45, ≤1:0.50, ≤1:0.55, ≤1:0.60, ≤1:0.65, ≤1:0.70, ≤1:0.75, ≤1:0.80, ≤1:0.85, ≤1:0.90, ≤1:0.95, ≤1:1.00, ≤1:1.05, ≤1:1.10, ≤1:1.15, ≤1:1.20, ≤1:1.25, ≤1:1.30, ≤1:1.35, ≤1:1.40, ≤1:1.45, ≤1:1.50, ≤1:1.55, ≤1:1.60, ≤1:1.65, ≤1:1.70, ≤1:1.75, ≤1:1.80, ≤1:1.85, ≤1:1.90, ≤1:1.95, ≤1:2.00, ≤1:2.05, ≤1:2.10, ≤1:2.15, ≤1:2.20, ≤1:2.25, ≤1:2.30 or ≤1:2.35. Preferably, a concentration of the at least one texturizing agent to the at least one instant grain is ≤1:1.25, more preferably ≤1:2.50.

In one embodiment a concentration ratio of the at least one texturizing agent to the at least one instant grain is 1.00:49.00 to 49.00:1.00. In one embodiment a concentration ratio of the at least one texturizing agent to the at least one instant grain is 1:8 to 1:0.3, such as 1:7.33 to 1:0.43 or 1:7.00 to 1:0.43. In one embodiment a concentration ratio of the at least one texturizing agent to the at least one instant grain is 1:5.5 to 1:0.8, such as 1:5.25 to 1:1. Preferably, a concentration ratio of the at least one texturizing agent to the at least one instant grain is 1:5 to 1:1.25, more preferably 1:4.56 to 1:1.50. In a most preferred embodiment, a concentration ratio of the at least one texturizing agent to the at least one instant grain is 1:4.25 to 1:3.00, such as 1:4.2 to 1:3.8.

Where a plurality of (two or more) texturizing agents is used, said texturizing agents may be used at a ratio of a first texturizing agent to a second texturizing agent of 1:2 to 2:1, preferably 1:1.

In one embodiment a concentration ratio of the plurality of texturizing agents to the instant grain is 1.00:49.00 to 49.00:1.00. In one embodiment a concentration ratio of the plurality of texturizing agents to the instant grain is 1:8 to 1:0.3, such as 1:7.33 to 1:0.43 or 1:7.00 to 1:0.43. In one embodiment a concentration ratio of the plurality of texturizing agents to the instant grain is 1:5.5 to 1:0.8, such as 1:5.25 to 1:1. Preferably, a concentration ratio of the plurality of texturizing agents to the instant grain is 1:5 to 1:1.25, more preferably 1:4.56 to 1:1.50. In a most preferred embodiment, a concentration ratio of the plurality of texturizing agents to the instant grain is 1:4.25 to 1:3.00, such as 1:4.2 to 1:3.8.

In a preferred embodiment, the invention provides a dry congee composition.

Said dry congee composition preferably comprises:
a. an instant rice grain;
b. a first texturizing agent, wherein the first texturizing agent is a puffed rice; and
c. a second texturizing agent, wherein the second texturizing agent is an instant oat,
   wherein the concentration ratio of the first and second texturizing agents to the instant rice grain is at least 1.00:49.00.

In one embodiment a dry congee composition comprises:
a. a plurality of instant grains (e.g. two instant grains), wherein at least one instant grain is an instant rice grain; and
b. at least one texturizing agent;
   wherein a concentration ratio of the at least one texturizing agent to the plurality of instant grains is at least 1.00:49.00.

For example, a dry congee composition may comprise:
a. a plurality of instant grains (e.g. two instant grains), wherein at least one instant grain is an instant rice grain;
b. a first texturizing agent, wherein the first texturizing agent is a puffed rice; and
c. a second texturizing agent, wherein the second texturizing agent is an instant oat,
   wherein the concentration ratio of the first and second texturizing agents to the plurality of instant grains is at least 1.00:49.00.

In another preferred embodiment, the invention provides a ready-to-eat congee food product. Said ready-to-eat congee food product preferably comprises:
a. an instant rice grain;
b. a first texturizing agent, wherein the first texturizing agent is a puffed rice; and
c. a second texturizing agent, wherein the second texturizing agent is an instant oat,
   wherein the concentration ratio of the first and second texturizing agents to the instant rice grain is at least 1.00:49.00.

In one embodiment a ready-to-eat congee food product comprises:
a. a plurality of instant grains (e.g. two instant grains), wherein at least one instant grain is an instant rice grain; and
b. at least one texturizing agent;
   wherein a concentration ratio of the at least one texturizing agent to the plurality of instant grains is at least 1.00:49.00.

For example, a ready-to-eat congee food product may comprise:
a. a plurality of instant grains (e.g. two instant grains), wherein at least one instant grain is an instant rice grain;
b. a first texturizing agent, wherein the first texturizing agent is a puffed rice; and
c. a second texturizing agent, wherein the second texturizing agent is an instant oat,
   wherein the concentration ratio of the first and second texturizing agents to the plurality of instant grains is at least 1.00:49.00.

Preferably the concentration ratio of the first texturizing agent to the second texturizing agent is 1:2 to 2:1, more preferably 1:1.

In one embodiment a concentration ratio of the first and second texturizing agents to the instant rice grain is 1.00:49.00 to 49.00:1.00. In one embodiment a concentration ratio of the first and second texturizing agents to the instant rice grain is 1:8 to 1:0.3, such as 1:7.33 to 1:0.43 or 1:7.00 to 1:0.43. In one embodiment a concentration ratio of the first and second texturizing agents to the instant rice grain is 1:5.5 to 1:0.8, such as 1:5.25 to 1:1. Preferably, a concentration ratio of the first and second texturizing agents to the instant rice grain is 1:5 to 1:1.25, more preferably 1:4.56 to 1:1.50. In a most preferred embodiment, a concentration ratio of the first and second texturizing agents to the instant rice grain is 1:4.25 to 1:3.00, such as 1:4.2 to 1:3.8.

In a preferred embodiment, the invention provides a dry oat porridge composition. Said dry oat porridge composition preferably comprises:
a. an instant oat grain;
b. a first texturizing agent, wherein the first texturizing agent is a puffed rice; and
c. a second texturizing agent, wherein the second texturizing agent is an oat flake,
   wherein the concentration ratio of the first and second texturizing agents to the instant rice grain is at least 1.00:49.00.

In another preferred embodiment, the invention provides a ready-to-eat oat porridge food product. Said ready-to-eat oat porridge food product preferably comprises:
a. an instant rice grain;
b. a first texturizing agent, wherein the first texturizing agent is a puffed rice; and
c. a second texturizing agent, wherein the second texturizing agent is an oat flake,
   wherein the concentration ratio of the first and second texturizing agents to the instant rice grain is at least 1.00:49.00.

In one aspect the invention provides a method for manufacturing a dry composition, the method comprising:
a. admixing at least one instant grain and at least one texturizing agent, wherein the at least one texturizing agent is admixed with the at least one instant grain at a concentration ratio of the at least one texturizing agent to the instant grain of at least 1.00:49.00, thereby providing a dry composition (e.g. a dry grain-based composition); and
b. optionally packaging.

Preferably the dry composition (e.g. dry grain-based composition) is packaged.

Thus, the invention also provides a dry composition obtainable by a method of the invention, e.g. a packaged dry composition obtainable by a method of the invention.

In one embodiment a method comprises admixing dehydrated ingredients. In another embodiment a method comprises admixing hydrated ingredients and subsequently dehydrating the admix. The dehydrated ingredients may be dehydrated using any technique known to the skilled person, such as freeze drying.

The term “admixing” as used herein means the mixing of at least one ingredient with one or more further ingredient(s). The term “admixing” as used herein refers to mixing constituents in any order, including mixing sequentially or simultaneously. Suitably the term “admixing” may refer to the sequential mixing of constituents. The mixture obtained by admixing may be referred to herein as an “admixture”.

In one aspect there is provided a method for preparing a ready-to-eat food product, the method comprising:
a. providing the dry composition of the present invention;
b. adding water or a formulation comprising water; and
c. heating, thereby providing the ready-to-eat food product.

There is also provided a ready-to-eat food product obtainable by a method of the invention.

A ready-to-eat food product described herein preferably comprises water.

The term “obtainable” as used herein also encompasses the term “obtained”. In one embodiment the term “obtainable” means obtained.

Thus, in a particularly preferred embodiment a food product of the invention is a product to be consumed hot (i.e. a “hot” or “cooked” product). A hot product may have temperature of at least 30° C., 40° C., 50° C., 60° C., 70° C., 80° C. or 90° C.

Preferably, a method of the invention comprises adding hot water or a formulation comprising water (e.g. milk) (e.g. having a temperature of at least 50° C., 60° C., 70° C., 80° C. or 90° C.) to the dry composition. In such embodiments it may not be necessary to provide further heat, as the heating step may be achieved by the temperature of the water or the formulation comprising water.

In one embodiment, water is added and the mixture is heated using a microwave, e.g. if the water added is not hot (e.g. has a temperature of less than 40° C., 30° C. or 25° C.).

In one embodiment a formulation comprising water is added and the mixture is heated (e.g. to a temperature of at least 50° C., 60° C., 70° C., 80° C. or 90° C.) using a microwave, e.g. if the formulation comprising water that is added is not hot. Preferably the formulation comprising water is milk.

The composition is preferably stirred after adding the water or formulation comprising water for up to 40 seconds, e.g. 20-30 seconds.

In one embodiment the composition may be heated (e.g. to a temperature of at least 50° C., 60° C., 70° C., 80° C. or 90° C.) for at least 1, 2 or 3 minutes. The composition may be heated for 5 or fewer minutes, e.g. 4 or fewer minutes. In one embodiment the composition is heated for 1-5 minutes, preferably 2-4 minutes.

Where the water or composition comprising water is hot, the composition may be left to heat (e.g. to a temperature of at least 50° C., 60° C., 70° C., 80° C. or 90° C.) for at least 1, 2 or 3 minutes. The composition may be left to heat for 5 or fewer minutes, e.g. 4 or fewer minutes. In one embodiment the composition is left to heat for 1-5 minutes, preferably 2-4 minutes. Suitably, the composition is left to heat after being stirred.

Thus, it is intended that the food product of the invention is an instant food product and that the composition is suitable for preparing an instant food product. The term “instant food product” as used in this context means that the product exhibits desirable/acceptable organoleptic properties (e.g. texture profile, such as substantially no uncooked/undercooked grains) by heating for up to 5 minutes (preferably by heating for up to 3 minutes) without the addition of further external heat (e.g. by simmering for example on a hob or heating in a microwave). In one embodiment the term “instant food product” as used in this context means that the product exhibits desirable/acceptable organoleptic properties (e.g. texture profile, such as substantially no uncooked/undercooked grains) when boiling water is added to the product and left to heat for up to 5 minutes (preferably for up to 3 minutes) without the addition of further external heat (e.g. by simmering for example on a hob or heating in a microwave). The term “instant food product” is preferably intended to exclude a “quick cook food product” requiring the addition of water/milk, heating until boiling (or close to boiling) and in a microwave and/or simmering, for example on a hob (e.g. for up to 5 minutes or for up to 3 minutes, such as 3-5 minutes) to obtain a product having desirable/acceptable organoleptic properties (e.g. texture profile, such as substantially no uncooked/undercooked grains). In one embodiment the term “instant food product” excludes a “quick cook food product” requiring the addition of boiling water/milk, and heating in a microwave and/or simmering for example on a hob (e.g. for up to 5 minutes or for up to 3 minutes, such as 3-5 minutes) to obtain a product having desirable/acceptable organoleptic properties (e.g. texture profile, such as substantially no uncooked/undercooked grains). The term “substantially no uncooked/undercooked grains” may mean that less than 5%, 3% or 1% of the grains are uncooked/undercooked.

The term “organoleptic properties” as used herein refers to sensory properties, such as texture, taste, smell, sight, and/or touch (preferably texture).

In a preferred embodiment an instant oat grain or oat flake of the invention has not been infused in a solution comprising low molecular weight infusion solutes, such as polyols, sugars and/or salts.

In one embodiment, a composition or food product of the present invention does not comprise a cereal flour. Preferably, a composition or food product does not comprise a rice flour, an oat flour, a wheat flour, a corn flour or combinations thereof.

In one embodiment, a composition or food product of the present invention does not comprise a soybean flour or a millet flour.

In one embodiment, a composition or food product of the invention does not comprise a gelatinized and/or pregelatinized cereal. For example, a composition or food product of the invention may not comprise a gelatinized and/or pregelatinized oat (e.g. oat flake) and/or gelatinized and/or pregelatinized rice.

Various flavours and/or colours may be present in a composition or food product of the invention. The person skilled in the art is aware of suitable flavours for use in a product (e.g. an oat porridge or rice porridge, such as congee). Examples of suitable flavours (especially for oat porridge) include fruits, such as apple and peach; spices, including cinnamon and nutmeg; and other flavours, such as brown sugar, maple, and nuts, including walnuts and pecans. Further examples of suitable flavours (especially for a rice porridge, such as congee) include: chicken, fish, seafood (e.g. shrimp), fungus (e.g. mushroom), onions, ginger, soy, salt, and pepper.

In some embodiments the flavours may be added to a dry composition in a freeze-dried form, which are then rehydrated when preparing the food product.

Miscellaneous materials, such as sugar, salts (sodium chloride, potassium chloride, and others), other flavouring agents, vitamins and minerals, oils, butylated hydroxytoluene and other preservatives, packaging agents such as anti-clumping agents, and other materials may also be present. The skilled practitioner will be able to identify other constituents that are well-known in, and compatible with, compositions/products in general and the composition/product of the invention in particular, and will be able to determine the correct quantity for use with the embodiments of the invention.

Embodiments related to the various compositions of the invention are intended to be applied equally to the ready-to-eat food product, and the methods, and vice versa.

Unless defined otherwise, all technical and scientific terms used herein have the same meaning as commonly understood by one of ordinary skill in the art to which this disclosure belongs.

This disclosure is not limited by the exemplary methods and materials disclosed herein, and any methods and materials similar or equivalent to those described herein can be used in the practice or testing of embodiments of this disclosure. Numeric ranges are inclusive of the numbers defining the range.

The headings provided herein are not limitations of the various aspects or embodiments of this disclosure.

Other definitions of terms may appear throughout the specification. Before the exemplary embodiments are described in more detail, it is to be understood that this disclosure is not limited to particular embodiments described, and as such may vary. It is also to be understood that the terminology used herein is for the purpose of describing particular embodiments only, and is not intended to be limiting, since the scope of the present disclosure will be defined only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within this disclosure. The upper and lower limits of these smaller ranges may independently be included or excluded in the range, and each range where either, neither or both limits are included in the smaller ranges is also encompassed within this disclosure, subject to any specifically excluded limit in the stated range. Where the stated range includes one or both of the limits, ranges excluding either or both of those included limits are also included in this disclosure.

It must be noted that as used herein and in the appended claims, the singular forms “a”, “an”, and “the” include plural referents unless the context clearly dictates otherwise. Thus, for example, reference to “an instant grain” includes a plurality of such candidate agents and reference to “the puffed grain” includes reference to one or more puffed grains and equivalents thereof known to those skilled in the art, and so forth.

The publications discussed herein are provided solely for their disclosure prior to the filing date of the present application. Nothing herein is to be construed as an admission that such publications constitute prior art to the claims appended hereto.

### BRIEF DESCRIPTION OF THE DRAWINGS

Embodiments of the invention will now be described, by way of example only, with reference to the following Figures and Examples.

FIG. 1 shows the mean textural rating of instant congee prepared using instant rice alone or instant rice and instant oats.

FIG. 2 shows the mean textural rating of instant congee prepared using instant rice alone or instant rice and puffed rice.

FIG. 3 shows the mean textural rating of instant congees prepared using instant rice alone or instant rice, puffed rice, and instant oats. Error bars show standard deviation around the mean (n=5).

### EXAMPLES

### Example 1

Congee with Instant Rice & Instant Oats

A mixture of instant rice and instant oats was prepared. The instant oats were “Gluten Free Porridge Oats”, obtained commercially from Morning Foods, UK. The instant oats had a mean average flake thickness of 0.36-0.46 mm (0.014-0.018 inches).

Specifically, 10 g of instant oats was mixed with 40 g of instant rice (giving a concentration of instant oats to instant rice of 1:4). 250 ml of boiling water was added and the product was stirred continuously for 20-30 seconds to ensure mixing and dispersion of ingredients and to break up any lumps. The product was left to stand for 3 minutes with no additional heating.

An expert taster compared the congee to a control (lacking the instant oats) and rated each instant congee based on a textural rating scale of 1 to 10, where: 1=poor gluey, uniform texture; and 10=perfect texture of slow-cooked congee with textural elements. The rating scale was calibrated based on a comparison with slow-cooked congee (rating=10).

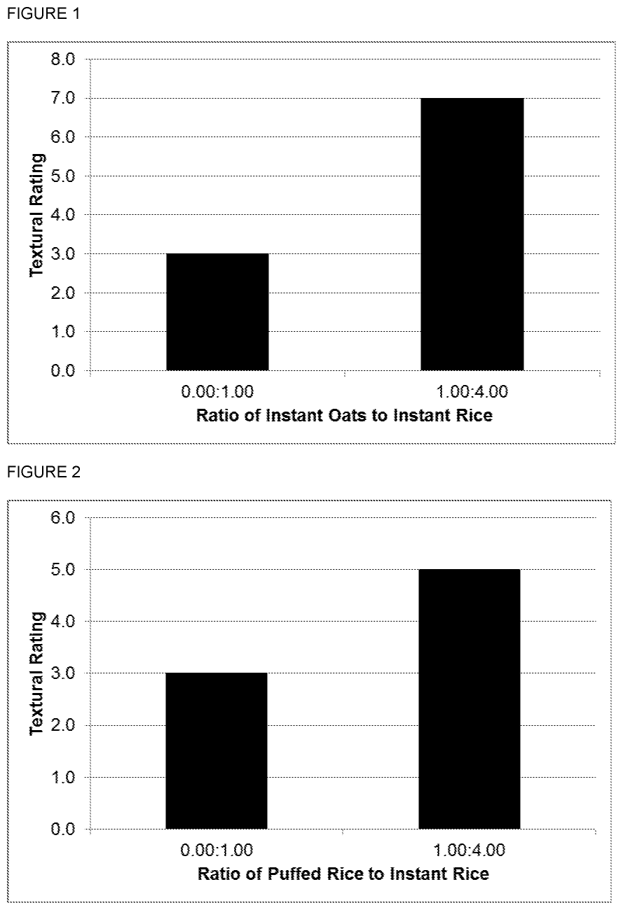

FIG. 1 shows that the addition of instant oats significantly improved the textural properties of the instant congee.

### Example 2

Congee with Instant Rice & Puffed Rice

A mixture of instant rice and puffed rice was prepared. The puffed rice was “Holland & Barrett Gluten Free Plain Puffed Rice” (SKU: 004643) obtained commercially from Holland & Barrett, UK. The puffed rice contained 100% brown puffed rice.

Specifically, 10 g of puffed rice was mixed with 40 g of instant rice (giving a concentration of puffed rice to instant rice of 1:4). The congee was prepared, hydrated, and heated as described in Example 1. An expert taster compared the congee to a control (lacking the instant oats) and rated according to the scale described in Example 1.

FIG. 2 shows that the addition of puffed rice significantly improved the textural properties of the instant congee.

### Example 3

Congee with Instant Rice, Puffed Rice Instant Oats & Puffed Rice

Mixtures of instant rice, puffed rice, and instant oats were prepared. In each mixture the ratio of puffed rice to instant oats was kept constant (1:1):

| Instant Oats + | Instant | Ratio of Instant Oats + |
|---|---|---|
| Puffed Rice (g) | Rice (g) | Puffed Rice to Instant Rice |
| 0 | 50 | 0.00:1.00 |
| 1 | 49 | 1.00:49.00 |
| 2.5 | 47.5 | 1.00:19.00 |
| 5 | 45 | 1.00:9.00 |
| 6 | 44 | 1.00:7.33 |
| 7 | 43 | 1.00:6.14 |
| 8 | 42 | 1.00:5.25 |
| 9 | 41 | 1.00:4.56 |
| 10 | 40 | 1.00:4.00 |
| 15 | 35 | 1.00:2.33 |
| 20 | 30 | 1.00:1.50 |
| 25 | 25 | 1.00:1.00 |
| 30 | 20 | 1.00:0.67 |
| 35 | 15 | 1.00:0.43 |
| 40 | 10 | 1.00:0.25 |
| 45 | 5 | 1.00:0.11 |

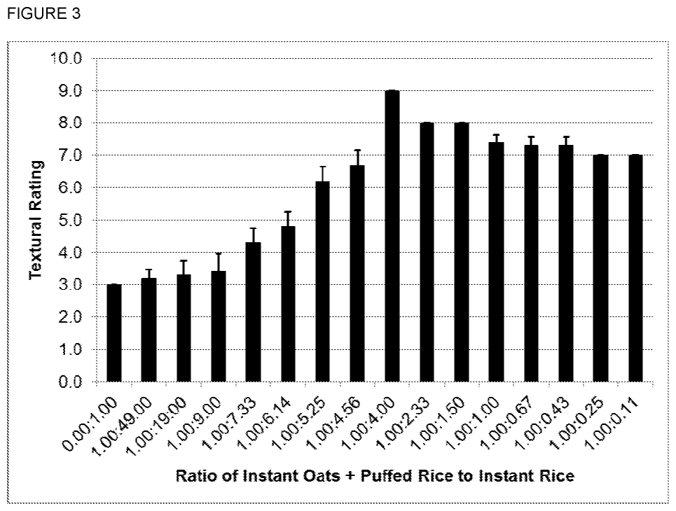

The congee was prepared, hydrated, and heated as described in Example 1. A panel of 5 expert tasters rated each of the instant congee preparations according to the textural rating scale of Example 1 and the results of the analysis are presented in FIG. 3.

By using a concentration ratio of instant oats and puffed rice to instant rice of at least 1:49, the textural properties of instant congee could be improved, such that the instant congee had textural properties similar to traditionally-cooked congee. Indeed, the improvement was exceptional at a concentration ratio of 1:5.25 to 1:1.50.

Surprisingly, by using both instant oats and puffed rice, the textural properties of the congee were much better than when either ingredient was used in isolation.

### Example 4

Porridge with Instant Oats & Puffed Rice

A porridge is prepared as a dry mixture containing the following wt. % of instant oats and puffed rice:

| Puffed | Instant | Ratio of Puffed Rice |
|---|---|---|
| Rice wt. % | Oats wt. % | to Instant Oats |
| 0% | 100% | 0.00:1.00 |
| 10% | 90% | 0.11:1.00 |
| 20% | 80% | 0.25:1.00 |
| 30% | 70% | 0.43:1.00 |
| 40% | 60% | 0.67:1.00 |
| 50% | 50% | 1.00:1.00 |
| 60% | 40% | 1.50:1.00 |
| 70% | 30% | 2.33:1.00 |
| 80% | 20% | 4.00:1.00 |
| 90% | 10% | 9.00:1.00 |
| 100% | 0% | 1.00:0.00 |

50 g of each mixture is weighed into cups. 250 ml of boiling water is added and the product is stirred continuously for 20-30 seconds to ensure mixing and dispersion of ingredients and to break up any lumps. The product is left to stand for 3 minutes with no additional heating.

The porridge is rated by expert tasters using the rating scale of 1 to 10, where: 1=poor gluey, uniform texture; and 10=perfect texture of slow-cooked porridge with textural elements. The rating scale is calibrated based on a comparison with slow-cooked porridge (rating=10).

Surprisingly, addition of puffed rice is found to improve the texture of the porridge.

### Example 5

Porridge with Instant Oats, Puffed Rice & Oat Flakes

An alternative porridge is prepared, which further includes oat flakes. The dry mixture contains the following:

| Puffed | Oat Flakes | Instant | Ratio of Puffed Rice + |
|---|---|---|---|
| Rice wt. % | wt. % | Oats wt. % | Oat Flakes to Instant Oats |
| 0% | 0% | 100% | 0.00:1.00 |
| 5% | 5% | 90% | 0.11:1.00 |
| 10% | 10% | 80% | 0.25:1.00 |
| 15% | 15% | 70% | 0.43:1.00 |
| 20% | 20% | 60% | 0.67:1.00 |
| 25% | 25% | 50% | 1.00:1.00 |
| 30% | 30% | 40% | 1.50:1.00 |
| 35% | 35% | 30% | 2.33:1.00 |
| 40% | 40% | 20% | 4.00:1.00 |
| 45% | 45% | 10% | 9.00:1.00 |
| 50% | 50% | 0% | 1.00:0.00 |

The dry porridge mixture is heated and a textural analysis performed by expert tasters as per Example 4. Advantageously, the inclusion of oat flakes in addition to the puffed rice provides porridge with a much-improved texture, which closely approaches that of traditional (non-instant) porridge.

### Example 6

Porridge with Instant Oats, Puffed Rice & Oat Flakes

Based on the findings of Example 4 a preferred porridge is prepared. The dry mixture contains the following:

| | | Grams per Pack |
|---|---|---|
| Ingredient | wt. % | (70.0 g total) |
| Coconut milk powder | 27.1 | 19.0 |
| Gluten-free instant oats | 42.9 | 30.0 |
| Gluten-free oat flakes | 15.0 | 10.5 |
| Plain puffed rice | 12.9 | 9.0 |
| Flavourings/other ingredients | 2.1 | 1.5 |

### Example 7

Congee Recipe A

A preferred congee is prepared based on the findings of Examples 1-3. The dry mixture contains the following:

| | | Grams per Pack |
|---|---|---|
| Ingredient | wt. % | (54.6 g total) |
| Instant rice | 31.2 | 17.00 |
| Gluten-free instant oats | 18.8 | 10.25 |
| Gluten-free brown rice flakes | 2.7 | 1.50 |
| Plain puffed rice | 16.5 | 9.00 |
| Flavourings/other ingredients | 30.8 | 16.82 |

### Example 8

Congee Recipe B

An alternative preferred congee is prepared. The dry mixture contains the following:

| | | Grams per Pack |
|---|---|---|
| Ingredient | wt. % | (60.3 g total) |
| Instant rice | 58.0 | 35.00 |
| Gluten-free instant oats | 8.3 | 5.00 |
| Plain puffed rice | 9.1 | 5.50 |
| Flavourings/other ingredients | 24.6 | 14.83 |

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in food technology, formulation chemistry or related fields are intended to be within the scope of the following claims.

1. A dry composition for preparing a food product, the composition comprising:
a. at least one instant grain; and
b. at least one texturizing agent;
wherein a concentration ratio of the at least one texturizing agent to the at least one instant grain is at least 1.00:49.00.

2. A ready-to-eat food product, the food product comprising:
a. at least one instant grain; and
b. at least one texturizing agent;
wherein a concentration ratio of the at least one texturizing agent to the at least one instant grain is at least 1.00:49.00.

3. The composition according to claim 1 or the food product according to claim 2, wherein the at least one texturizing agent is a puffed grain.

4. The composition or food product according to any one of the preceding claims, comprising an instant rice and a puffed grain.

5. The composition or food product according to any one of the preceding claims, wherein the at least one texturizing agent is one or more selected from: a puffed rice, a puffed corn, a puffed quinoa, a puffed wheat, and a puffed amaranth.

6. The composition or food product according to claim 5, wherein the puffed corn is popped corn and/or the puffed quinoa is popped quinoa.

7. The composition or food product according to any one of claims 1-5, wherein the puffed grain is a puffed rice.

8. The composition according to claim 1 or the food product according to claim 2, wherein the at least one texturizing agent is a baked grain product.

9. The composition or food product according to claim 8, wherein the baked grain product is a biscuit.

10. The composition or food product according to claim 8 or 9, wherein the baked grain product is a wafer.

11. The composition according to any one of the preceding claims, wherein the concentration ratio of the at least one texturizing agent to the at least one instant grain is 1.00:8.00 to 1.00:0.30.

12. The composition or food product according to any one of the preceding claims, wherein the concentration ratio of the at least one texturizing agent to the at least one instant grain is 1.00:5.50 to 1.00:0.80.

13. The composition or food product according to any one of the preceding claims, wherein the concentration ratio of the at least one texturizing agent to the at least one instant grain is 1.00:5.00 to 1.00:1.25.

14. The composition or food product according to any one of the preceding claims, wherein the concentration ratio of the at least one texturizing agent to the at least one instant grain is 1.00:4.25 to 1.00:3.00.

15. The composition or food product according to any one of the preceding claims, wherein the at least one texturizing agent is a grain-based texturizing agent.

16. The composition or food product according to any one of claim 1-2 or 11-15, wherein the at least one texturizing agent is one or more selected from the group consisting of: a puffed grain; an (second) instant grain; a flaked grain; and a baked grain product.

17. The composition or food product according to claim 16, wherein the instant grain is different to the instant grain of part a.

18. The composition or food product according to any one of claim 1-3 or 5-17, wherein the instant grain is one or more selected from the group consisting of: rice, oat, wheat, quinoa, millet, barley, corn, triticale, sorghum, rye, spelt, wild rice, chia, amaranth, and buckwheat.

19. The composition or food product according to any one of claim 1-2 or 11-17, wherein the at least one texturizing agent is an instant grain selected from the group consisting of: rice, oat, wheat, quinoa, millet, barley, corn, triticale, sorghum, rye, spelt, wild rice, chia, amaranth, and buckwheat.

20. The composition or food product according to any one of claim 1-2 or 11-18, wherein the at least one texturizing agent is one or more selected from oat flakes and rice flakes.

21. The composition or food product according to claim 20, wherein the oat flakes have a mean average thickness of at least 0.508 mm.

22. The composition or food product according to claim 20 or 21, wherein the oat flakes have a mean average thickness of greater than 0.508 mm.

23. The composition or food product according to any one of claim 1-3 or 5-22, wherein the instant grain is an instant oat grain having a mean average thickness of less than 0.483 mm.

24. The composition or food product according to any one of claim 1-3 or 5-23, wherein the instant grain is an instant oat grain having a mean average thickness of 0.36-0.46 mm.

25. The composition or food product according to any one of the preceding claims, wherein the composition or food product does not comprise quick cook oats.

26. The composition or food product according to any one of the preceding claims, wherein the composition or food product does not comprise a cereal flour.

27. The composition or food product according to any one of claim 1-22 or 25-26, wherein the food product is congee.

28. The composition or food product according to claim 27, wherein the congee comprises an instant rice; and at least one texturizing agent selected from a puffed grain and an (second) instant grain.

29. The composition or food product according to any one of claim 1, 2, 11-19 or 23-28, wherein the at least one texturizing agent is an instant oat.

30. The composition or food product according to any one of the preceding claims, wherein the at least one instant grain of part a. is at least two instant grains and wherein a concentration ratio of the at least one texturizing agent to the at least two instant grains is at least 1.00:49.00.

31. The composition or food product according to claim 30, wherein the at least one instant grain of part a. consists of two instant grains and wherein a concentration ratio of the at least one texturizing agent to the two instant grains is at least 1.00:49.00.

32. The composition or food product according to any one of the preceding claims, comprising at least two texturizing agents.

33. The composition or food product according to claim 32, wherein the concentration ratio of the at least two texturizing agents to the at least one instant grain is at least 1.00:49.00.

34. The composition or food product according to claim 32 or 33, wherein the concentration ratio of the at least two texturizing agents to the at least one instant grain is 1.00:8.00 to 1.00:0.30.

35. The composition or food product according to any one of claims 32-34, wherein the concentration ratio of the at least two texturizing agents to the at least one instant grain is 1.00:5.50 to 1.00:0.80.

36. The composition or food product according to any one of claims 32-35, wherein the concentration ratio of the at least two texturizing agents to the at least one instant grain is 1.00:5.00 to 1.00:1.25.

37. The composition or food product according to any one of claims 32-36, wherein the concentration ratio of the at least two texturizing agents to the at least one instant grain is 1.00:4.25 to 1.00:3.00.

38. The composition or food product according to any one of claims 32-37, wherein the at least two texturizing agents comprise a puffed grain and an instant grain.

39. The composition or food product according to claim 38, wherein the instant grain is different to the instant grain of part a.

40. The composition or food product according to any one of claims 32-39, wherein the at least two texturizing agents comprise a puffed rice and an instant oat.

41. The composition or food product according to any one of the preceding claims, wherein the at least one texturizing agent consists of two texturizing agents.

42. The composition or food product according to claim 41, wherein the concentration ratio of the two texturizing agents to the at least one instant grain is at least 1.00:49.00.

43. The composition or food product according to claim 41 or 42, wherein the concentration ratio of the two texturizing agents to the at least one instant grain is 1.00:8.00 to 1.00:0.30.

44. The composition or food product according to any one of claims 41-43, wherein the concentration ratio of the two texturizing agents to the at least one instant grain is 1.00:5.50 to 1.00:0.80.

45. The composition or food product according to any one of claims 41-44, wherein the concentration ratio of the two texturizing agents to the at least one instant grain is 1.00:5.00 to 1.00:1.25.

46. The composition or food product according to any one of claims 41-45, wherein the concentration ratio of the two texturizing agents to the at least one instant grain is 1.00:4.25 to 1.00:3.00.

47. The composition or food product according to any one of claims 32-46, wherein a concentration ratio of the first texturizing agent to the second texturizing agent is 1:2 to 2:1.

48. The composition or food product according to any one of claims 32-47, wherein a concentration ratio of the first texturizing agent to the second texturizing agent is 1:1.

49. The composition or food product according to any one of the preceding claims, wherein the texturizing agent is an ingredient that improves a textural property of a ready-to-eat food product prepared from the dry composition when compared to an equivalent ready-to-eat food product prepared from an equivalent dry composition that does not comprise the ingredient.

50. The composition or food product according to claim 49, wherein the ready-to-eat food product resembles a slow-cooked version of the product.

51. A method for manufacturing a dry composition (e.g. a dry composition according to any one of claim 1 or 3-50), the method comprising:
a. admixing at least one instant grain and at least one texturizing agent, wherein the at least one texturizing agent is admixed with the at least one instant grain at a concentration ratio of the at least one texturizing agent to the at least one instant grain of at least 1.00:49.00, thereby providing a dry composition; and
b. optionally packaging.

52. The method according to claim 51, wherein the at least one texturizing agent is a puffed grain.

53. The method according to claim 51 or 52, comprising admixing an instant rice and a puffed grain.

54. The method according to any one of claims 51-53, wherein the at least one texturizing agent is one or more selected from: a puffed rice, a puffed corn, a puffed quinoa, a puffed wheat, and a puffed amaranth.

55. The method according to claim 54, wherein the puffed corn is popped corn and/or the puffed quinoa is popped quinoa.

56. The method according to any one of claims 51-54, wherein the puffed grain is a puffed rice.

57. The method according to claim 51, wherein the at least one texturizing agent is a baked grain product.

58. The method according to claim 57, wherein the baked grain product is a biscuit.

59. The method according to claim 57 or 58, wherein the baked grain product is a wafer.

60. The method according to any one of claims 51-59, wherein the at least one texturizing agent is admixed with the at least one instant grain at a concentration ratio of the at least one texturizing agent to the at least one instant grain of 1.00:8.00 to 1.00:0.30.

61. The method according to any one of claims 51-60, wherein the at least one texturizing agent is admixed with the at least one instant grain at a concentration ratio of the at least one texturizing agent to the at least one instant grain of 1.00:5.50 to 1.00:0.80.

62. The method according to any one of claims 51-61, wherein the at least one texturizing agent is admixed with the at least one instant grain at a concentration ratio of the at least one texturizing agent to the at least one instant grain of 1.00:5.00 to 1.00:1.25.

63. The method according to any one of claims 51-62, wherein the at least one texturizing agent is admixed with the at least one instant grain at a concentration ratio of the at least one texturizing agent to the at least one instant grain of 1.00:4.25 to 1.00:3.00.

64. The method according to any one of claims 51-63, wherein the at least one texturizing agent is a grain-based texturizing agent.

65. The method according to any one of claim 51 or 60-64, wherein the at least one texturizing agent is one or more selected from the group consisting of: a puffed grain; an (second) instant grain; a flaked grain; and a baked grain product.

66. The method according to claim 65, wherein the instant grain is different to the instant grain of part a.

67. The method according to any one of claim 51-52 or 54-66, wherein the instant grain is one or more selected from the group consisting of: rice, oat, wheat, quinoa, millet, barley, corn, triticale, sorghum, rye, spelt, wild rice, chia, amaranth, and buckwheat.

68. The method according to any one of claim 51 or 60-67, wherein the at least one texturizing agent is an instant grain selected from the group consisting of: rice, oat, wheat, quinoa, millet, barley, corn, triticale, sorghum, rye, spelt, wild rice, chia, amaranth, and buckwheat.

69. The method according to any one of claim 51 or 60-67, wherein the at least one texturizing agent is one or more selected from oat flakes and rice flakes.

70. The method according to claim 69, wherein the oat flakes have a mean average thickness of at least 0.508 mm.

71. The method according to claim 69 or 70, wherein the oat flakes have a mean average thickness of greater than 0.508 mm.

72. The method according to any one of claim 51-52 or 54-71, wherein the instant grain is an instant oat grain having a mean average thickness of less than 0.483 mm.

73. The method according to any one of claim 51-52 or 54-72, wherein the instant grain is an instant oat grain having a mean average thickness of 0.36-0.46 mm.

74. The method according to any one of claims 51-73, wherein the method does not comprise the use of quick cook oats.

75. The method according to any one of claims 51-74, wherein the method does not comprise the use of a cereal flour.

76. The method according to any one of claim 51-71 or 74-75, wherein the food product is congee.

77. The method according to claim 76, wherein the congee is manufactured by admixing an instant rice; and at least one texturizing agent selected from a puffed grain and an (second) instant grain.

78. The method according to any one of claim 51 or 60-68 or 72-77, wherein the at least one texturizing agent is an instant oat.

79. The method according to any one of claims 51-78, wherein at least two instant grains and at least one texturizing agent are admixed at a concentration ratio of the at least one texturizing agent to the at least two instant grains of at least 1.00:49.00.

80. The method according to claim 79, wherein two instant grains and at least one texturizing agent are admixed at a concentration ratio of the at least one texturizing agent to the two instant grains of at least 1.00:49.00.

81. The method according to any one of claims 51-80, comprising admixing the at least one instant grain and at least two texturizing agents.

82. The method according to claim 81, wherein the at least two texturizing agents are admixed with the at least one instant grain at a concentration ratio of the at least two texturizing agents to the at least one instant grain of at least 1.00:49.00

83. The method according to claim 81 or 82, wherein the at least two texturizing agents are admixed with the at least one instant grain at a concentration ratio of the at least two texturizing agents to the at least one instant grain of 1.00:8.00 to 1.00:0.30.

84. The method according to any one of claims 81-83, wherein the at least two texturizing agents are admixed with the at least one instant grain at a concentration ratio of the at least two texturizing agents to the at least one instant grain of 1.00:5.50 to 1.00:0.80.

85. The method according to any one of claims 81-84, wherein the at least two texturizing agents are admixed with the at least one instant grain at a concentration ratio of the at least two texturizing agents to the at least one instant grain of 1.00:5.00 to 1.00:1.25.

86. The method according to any one of claims 81-85, wherein the at least two texturizing agents are admixed with the at least one instant grain at a concentration ratio of the at least two texturizing agents to the at least one instant grain of 1.00:4.25 to 1.00:3.00.

87. The method according to any one of claims 81-86, wherein the at least two texturizing agents comprise a puffed grain and an instant grain.

88. The method according to claim 87, wherein the instant grain is different to the instant grain of part a.

89. The method according to any one of claims 81-88, wherein the at least two texturizing agents comprise a puffed rice and an instant oat.

90. The method according to any one of claims 51-89, wherein the at least one texturizing agent consists of two texturizing agents.

91. The method according to claim 90, wherein the two texturizing agents are admixed with the at least one instant grain at a concentration ratio of the two texturizing agents to the at least one instant grain of at least 1.00:49.00.

92. The method according to claim 90 or 91, wherein the two texturizing agents are admixed with the at least one instant grain at a concentration ratio of the two texturizing agents to the at least one instant grain of 1.00:8.00 to 1.00:0.30.

93. The method according to any one of claims 90-92, wherein the two texturizing agents are admixed with the at least one instant grain at a concentration ratio of the two texturizing agents to the at least one instant grain of 1.00:5.50 to 1.00:0.80.

94. The method according to any one of claims 90-93, wherein the two texturizing agents are admixed with the at least one instant grain at a concentration ratio of the two texturizing agents to the at least one instant grain of 1.00:5.00 to 1.00:1.25.

95. The method according to any one of claims 90-94, wherein the two texturizing agents are admixed with the at least one instant grain at a concentration ratio of the two texturizing agents to the at least one instant grain of 1.00:4.25 to 1.00:3.00.

96. The method according to any one of claims 81-95, wherein a concentration ratio of the first texturizing agent to the second texturizing agent is 1:2 to 2:1.

97. The method according to any one of claims 81-96, wherein a concentration ratio of the first texturizing agent to the second texturizing agent is 1:1.

98. A method for preparing a ready-to-eat food product (e.g. a ready-to-eat food product according to any one of claims 2-50), the method comprising:
a. providing the dry composition according to any one of claim 1 or 3-50;
b. adding water or a formulation comprising water; and
c. heating, thereby providing the ready-to-eat food product.

99. The method according to claim 98, wherein the heating is heating using a microwave or wherein the heating is heating using hot water or a formulation comprising water that is added in step b, and/or wherein the formulation comprising water is milk.
